(19) United States
(12) Patent Application Publication
(10) Pub. No.: US 2016/0091080 A1
(43) Pub. Date: Mar. 31, 2016

(54) TRANSMISSION LUBRICATION SYSTEM

(71) Applicant: Eaton Corporation, Cleveland, OH (US)

(72) Inventors: Robert Craft, Ceresco, MI (US); Judith Wright, Galesburg, MI (US); Timothy Smith, Mattawan, MI (US); Graeme Jackson, Kalamazoo, MI (US)

(21) Appl. No.: 14/962,027

(22) Filed: Dec. 8, 2015

Related U.S. Application Data
(63) Continuation-in-part of application No. 14/315,434, filed on Jun. 26, 2014.
(60) Provisional application No. 61/839,888, filed on Jun. 27, 2013.

(51) Int. Cl. F16H 57/04

(52) U.S. Cl. CPC F16H 57/046; F16H 57/042; F16H 57/0434

(57) ABSTRACT

A manifold for distributing lubricant in a transmission includes an inlet supply nozzle, a first body portion and a second body portion. The inlet supply nozzle receives transmission lubricant. The first body portion is in fluid communication with the supply nozzle and defines a first channel having a first open side along the first channel. The second body portion is in fluid communication with the supply nozzle and defines a second channel having a second open side along the second channel. The first and second body portions connect to form an assembled body in an assembled position such that the first and second channels collectively define a main tubular passage. A plurality of outlet ports can extend from the assembled body for dispersing lubricant from the main tubular passage across traction components of the transmission.

### CROSS-REFERENCE TO RELATED APPLICATIONS

This application is a continuation-in-part of U.S. patent application Ser. No. 14/315,434, filed on Jun. 26, 2014, which claims the benefit of U.S. Provisional Application No. 61/839,888, filed on Jun. 27, 2013. The disclosures of the above applications are incorporated herein in their entirety by reference.

### FIELD

The present disclosure relates to lubricant distribution for traction components of a vehicle transmission.

### BACKGROUND

Transmissions, such as vehicle transmissions, have one or more gear meshes that selectively transfer torque from an input shaft to an output shaft of the transmission. The gear meshes commonly require lubrication during transmission operation. The gear meshes and lubricant may be contained within a transmission case or housing, and a sump may be provided to collect the fluid and act as a reservoir.

Lubrication systems are used to circulate lubricant and provide sufficient a quantity of filtered lubricant to all the moving parts of a transmission. Several types of lubrication systems are known. For example, a system referred to as a splash system utilizes a splasher or dipper affixed to one or more of the moving traction parts within an internal cavity of the transmission case. The moving parts are cycled through lubricant within the sump during the movement of parts and lubricant is splashed about the internal cavity of the case. The splash may be diverted using internal features of the transmission such as veins or funnels that direct the flow of lubricant as it drains. Splash systems include a high volume of lubricant and may allow lubricant to slosh within the internal cavity. One problem with splash lubrication is that it is speed dependent. There can be centrifugal effects, hydrodynamic effects, and effects from the gears working as pumps that may reduce efficiency of the transmission.

Dry lubrication systems distribute lubricant differently compared to splash systems. In dry systems, a significantly smaller volume of lubricant is contained in a sump within the transmission. The lubricant is drawn out of the sump and diverted to the traction components as required. A complex series of tubes may be assembled in a dry system where each tube has particular shapes for diverting lubricant to specific locations within the transmission. The complex tubes may be steel tubes that are formed and joined to separate nozzles. Several different tubes may be assembled to a larger central tube, or may be joined to each other by a larger over-molded body. Assembly of a large number of customized parts is often expensive and may require complex tooling.

This disclosure is directed to solving the above problem and other problems as summarized below.

### SUMMARY

A manifold for distributing lubricant in a transmission includes an inlet supply nozzle, a first body portion and a second body portion. The inlet supply nozzle receives transmission lubricant. The first body portion is in fluid communication with the supply nozzle and defines a first channel having a first open side along the first channel. The second body portion is in fluid communication with the supply nozzle and defines a second channel having a second open side along the second channel. The first and second body portions connect to form an assembled body in an assembled position such that the first and second channels collectively define a main tubular passage. A male extension portion can be formed on one of the first and second body portions. A female receiving portion can be formed on the other of the first and second body portions. The male extension portion can be received by the female receiving portion in the assembled position. A plurality of outlet ports can extend from the assembled body for dispersing lubricant from the main tubular passage across traction components of the transmission.

According to other features, the inlet supply nozzle can comprise a completely formed annular end of one of the first and second body portions. The outlet port can comprise a first, a second and a third outlet port. The first outlet port can be arranged to direct lubricant onto a first gear mesh of the transmission. The second outlet port can be arranged to direct lubricant onto an auxiliary drive of the transmission. The third outlet port can be arranged at a terminal end of the manifold and arranged to direct lubricant onto an auxiliary reduction gear mesh of the transmission.

In other features, the outlet ports can further comprise a fourth outlet port and a fifth outlet port. The fourth outlet port can be configured to be fluidly connected to an upper reverse idler tube. The fifth outlet port can be configured to be fluidly connected to the lower idler tube. The fourth and fifth outlet ports can be defined in the inlet supply nozzle. The first body portion can include a first pair of outwardly extending flanges. The second body portion can include a second pair of outwardly extending flanges that oppose and engage the first pair of outwardly extending flanges in the assembled position.

According to further features, the male extension portion can be formed on a flange of the first pair of outwardly extending flanges and the female receiving portion can be formed on an opposing flange of the pair of outwardly extending flanges. The male extension portion can comprise at least two distinct male extension portions. A first male extension portion can extend from a flange of the first pair of outwardly extending flanges. A second male extension portion can extend from a flange of the second pair of outwardly extending flanges. The female receiving portion can comprise at least two distinct female receiving portions. A first female receiving portion can be formed on a flange of the first pair of outwardly extending flanges. A second female extension portion can extend from a flange of the second pair of outwardly extending flanges.

According to still other features, at least one clip can be disposed around opposing flanges of the first and second pairs of outwardly extending flanges. The clips can have opposite distal ends that are nestingly received into complementary grooves formed in the opposing flanges of the first and second pairs of outwardly extending flanges. The inlet supply nozzle can be formed on the second body portion. The first body portion can comprise an upwardly extending support bracket having an inert-molded torque limiter and pin that facilitate mounting of the upwardly extending support bracket to internal structure of the transmission.

A manifold for distributing lubricant in a transmission and constructed in accordance to another example of the present disclosure includes an inlet supply nozzle, a first body portion and a second body portion. The inlet supply nozzle receives transmission lubricant. The first body portion is in fluid communication with the supply nozzle and defines a first channel having a first open side along the first channel. The second body portion is in fluid communication with the supply nozzle and defines a second channel having a second open side along the second channel. The first and second body portions connect to form an assembled body in an assembled position such that the first and second channels collectively define a main tubular passage. A plurality of outlet ports can extend from the assembled body for dispersing lubricant from the main tubular passage across traction components of the transmission. The inlet supply nozzle can comprise a completely formed annular end of one of the first and second body portions.

According to other features, the manifold includes a male extension portion formed on one of the first and second body portions. A female receiving portion can be formed on the other of the first and second body portions. The male extension portion can be received by the female receiving portion in the assembled position.

In other features, the outlet ports can further comprise a fourth outlet port and a fifth outlet port. The fourth outlet port can be configured to be fluidly connected to an upper reverse idler tube. The fifth outlet port can be configured to be fluidly connected to the lower idler tube. The fourth and fifth outlet ports can be defined in the inlet supply nozzle. The first body portion can include a first pair of outwardly extending flanges. The second body portion can include a second pair of outwardly extending flanges that oppose and engage the first pair of outwardly extending flanges in the assembled position. The inlet supply nozzle can be formed on the second body portion. The first body portion can comprise an upwardly extending support bracket having an insert-molded torque limited and pin thereon. The insert-molded torque limiter and pin can facilitate mounting of the upwardly extending support bracket to internal structure of the transmission.

The above aspects of the disclosure and other aspects will be apparent to one of ordinary skill in the art in view of the attached drawings and the following detailed description of the illustrated examples.

### BRIEF DESCRIPTION OF THE DRAWINGS

FIG. 1 is a schematic side view of a transmission lubrication distribution system;

FIG. 2 is an elevation view of a first lubricant manifold;

FIG. 3 is a cross section taken along line 3-3 of FIG. 2;

FIG. 4 is a cross section taken along line 4-4 of FIG. 2;

FIG. 5 is an exploded perspective view of the first lubricant manifold of FIG. 2;

FIG. 6 is a perspective view of a second lubricant manifold;

FIG. 7 is a top perspective view of a manifold constructed in accordance to another example of the present disclosure;

FIG. 8 is a partial sectional view taken through a transmission lubrication distribution system that incorporates the manifold of FIG. 7 according to one example of the present disclosure;

FIG. 9 is an exploded view of the manifold of FIG. 7;

FIG. 10 is a sectional view of the manifold taken along lines 10-10 of FIG. 7;

FIG. 11A is a sectional view of the manifold taken along lines 11A-11A of FIG. 7;

FIG. 11B is a sectional view of the manifold taken along lines 11B-11B of FIG. 7;

FIG. 12 is a sectional view of the manifold taken along lines 12-12 of FIG. 7; and

FIG. 13 is a sectional view of the manifold taken along lines 13-13 of FIG.

### DETAILED DESCRIPTION

The illustrated examples are disclosed with reference to the drawings. However, it is to be understood that the disclosed examples are intended to be merely examples that may be embodied in various and alternative forms. The FIGS. are not necessarily to scale and some features may be exaggerated or minimized to show details of particular components. The specific structural and functional details disclosed are not to be interpreted as limiting, but as a representative basis for teaching one skilled in the art how to practice the disclosed concepts.

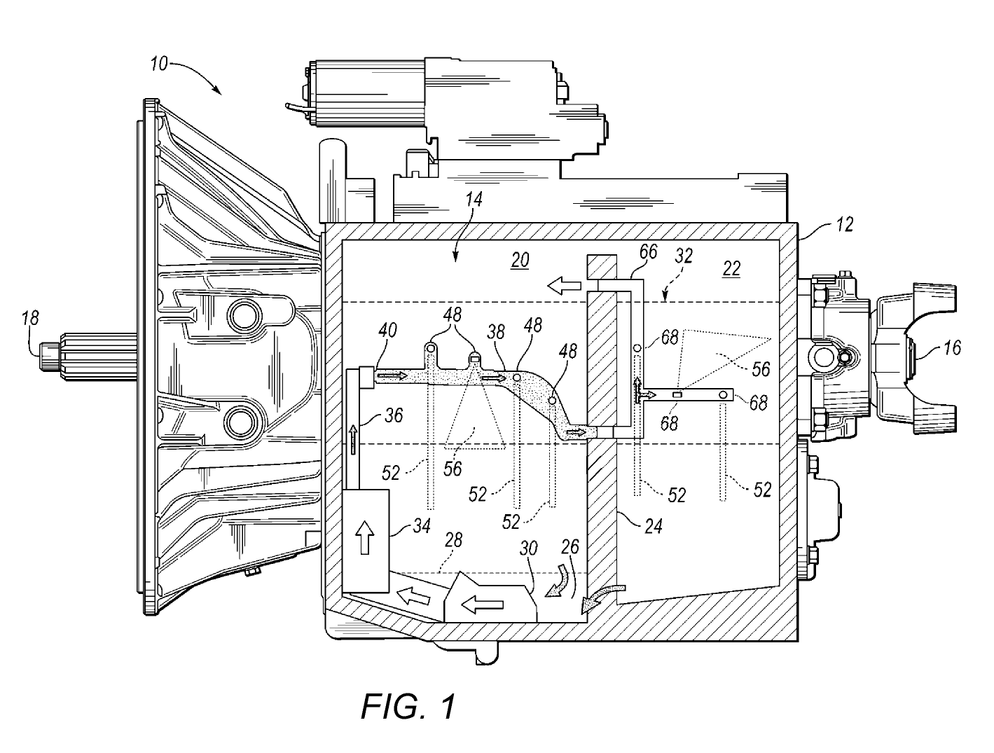

FIG. 1 depicts a lubrication system schematic of a transmission 10. The driveline components are hidden for clarity. The transmission 10 includes an outer housing, or case 12, defining an internal cavity 14 that contains components of the transmission 10. The case 12 may be made from one or more castings, forgings, or other parts. The transmission 10 receives input torque from an engine connection 18, and delivers output torque at the driveline connection 16. The case 12 encloses a gear train having a plurality of traction components that are adjustable to vary the ratios of both the speed and the torque of the output relative to the input. For example, the gear train may comprise meshed gears and/or planetary gear sets. The transmission 10 may also be connected to an auxiliary transmission to provide a wider ratio adjustment. The internal working components of the transmission 10 require sufficient lubrication to maintain efficient operation, reduce drag, and prevent excessive heat build-up.

According to an aspect of the present disclosure, a dry sump lubrication system is used to efficiently distribute transmission lubricant through the transmission 10. The dry sump configuration reduces drag losses caused by lubricant splash associated with a higher lubricant volume splash lubrication system. The internal cavity 14 defines a first section 20 and a second section 22, divided by a mid-wall 24. The first section 20 defines a sump 26, or reservoir, at a low point for collecting the lubricant. The maximum fill line 28 of the lubricant is lower than a maximum fill line of a splash type system because the moving components of the transmission 10 do not need to be substantially immersed in fluid. For example, in a dry lubrication system according to the present disclosure about twelve quarts of lubricant may be collected in the sump beneath the gear train traction components.

The lubrication system within the transmission case 12 is used to distribute the fluid lubricant from the sump 26. More efficient operation of the transmission is achieved by directing fluid lubricant to transmission traction components, generally housed in the region indicated by reference numeral 32. Active distribution of the fluid reduces the overall volume required to attain sufficient lubrication. The lubrication system is pressure driven and includes a strainer 30 and a pump 34. The pump 34 creates pressure and draws lubricant from the sump 26. A filter may be positioned near the intake of the pump 34 to restrict foreign particles from being cycled through the lubrication system. The lubrication system also may include a pressure regulator near an exhaust port of the pump 34 that opens when pressure in the system attains a predetermined value, for example, in the case of the filter clogging. Lubricant is forced through a supply tube 36 by the pump 34. The supply tube 36 is in fluid flow communication with a first manifold 38 that is arranged to distribute lubricant to the various transmission traction components 32.

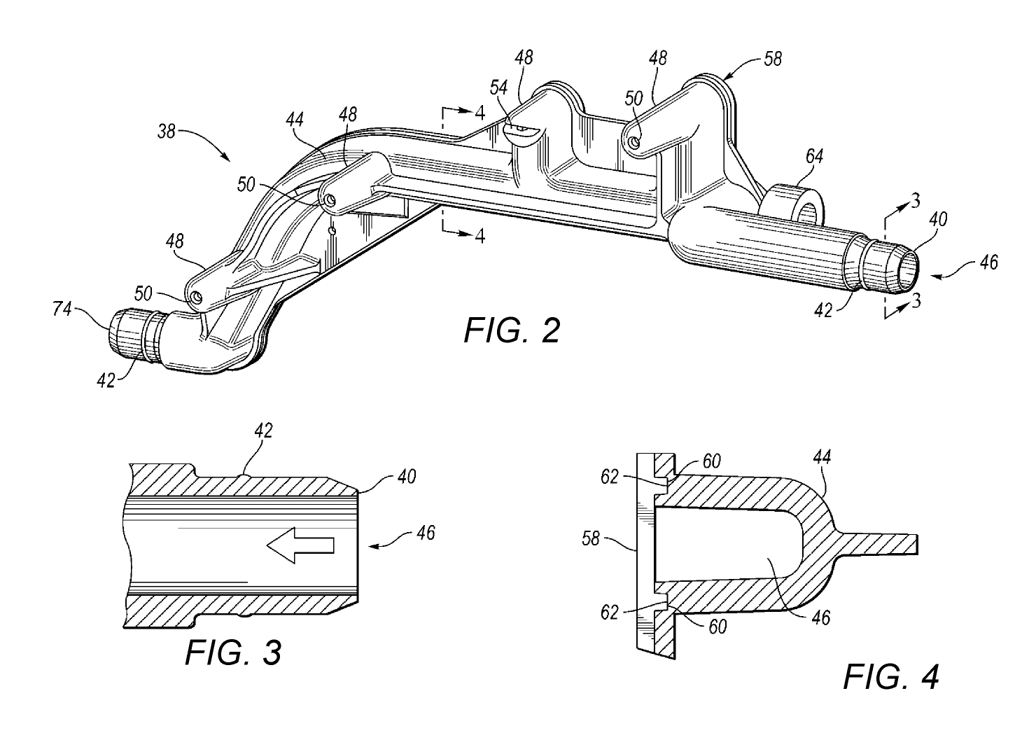

Referring to FIGS. 2 and 3, the first manifold 38 includes an inlet supply nozzle 40 to receive lubricant from the supply tube 36. At least one annular retaining rib 42 is integrally formed about the inlet supply nozzle 40 to create the fluid seal between the supply tube 36 and the first manifold 38. The integral annular retaining ribs 42 extend radially outward from the outer circumference of the inlet supply nozzle 40 and interfere with an inner surface of the supply tube 36. An exhaust nozzle 74 expels undispersed lubricant from the first manifold. The exhaust nozzle 74 may also include one or more integrally formed annular retaining ribs 42. Annular protrusions at the exhaust nozzle 74 may create a fluid seal to a circulation component arranged to direct the lubricant back to the sump 26 for recirculation. A separate assembled seal may not be required at either the inlet supply nozzle 40 or the exhaust nozzle 74. Alternatively, a lip or a fin may similarly be integrally formed into the manifold 38 to create a fluid seal.

Referring to FIGS. 2 and 4, the first manifold 38 also includes a main body portion 44 extending from the inlet supply nozzle 40. The main body 44 is generally elongate and defines an internal channel 46. Based on the relative placement of the individual traction components within the transmission 10, lubricant may need to be distributed in a transverse direction relative to the length of the main body 44. A plurality of outlet ports 48 extends laterally from the main body 44 to disperse lubricant as it flows through the first manifold 38. The outlet ports 48 are positioned at specific locations along the length of the main body 44 to direct a desired amount of lubricant towards specific components. The first manifold 38 is arranged generally to exhaust lubricant from the outlet ports 48 at an upper portion of the internal cavity 14 of the case 12. Gravity causes the lubricant to drain downwardly across the internal traction components of the transmission 10. The plurality of ports may be integrally formed with the main body as a single unitary member.

Referring to the schematic of FIG. 1, as well as FIG. 2, the outlet ports 48 of the first manifold 38 may have different types of configurations. The outlet ports 48 may define a simple orifice 50 that direct the lubricant exiting the manifold 38 in a solid stream spray pattern 52. Alternatively, the outlet ports 48 may have an elongate orifice 54 that directs the lubricant exiting the manifold 38 in a fan spray pattern 56 to provide a wider lubricant coverage area. Hollow cone spray patterns, solid cone spray patterns, and/or asymmetric variants of the above patterns may also be suitable to target internal components of the transmission 10 to provide a desired amount of lubricant. The plurality of ports may include a combination of different orifice types to output each of a solid stream spray pattern and a fan spray pattern. More specifically, a fan spray pattern may be more suitable to target a synchronizer traction component of the transmission 10 that requires broad coverage lubrication. A solid stream pattern may be more suitably targeted to specific locations along the gear mesh traction components within the transmission 10.

The first manifold 38 may be formed as an injection molded plastic manifold that integrates several geometric features into a single component. However, forming complex bends and formations requires an expensive injection molding tool having multiple components and articulating slides to create features that are not aligned with the main direction of die movement. The main body 44 of the manifold 38 may be formed with a channel that has an open side along the length to reduce tooling costs and complexity. Including an open sided channel allows the main body 44 of the manifold 38 to be an open body having features integrally formed in the main direction of die movement.

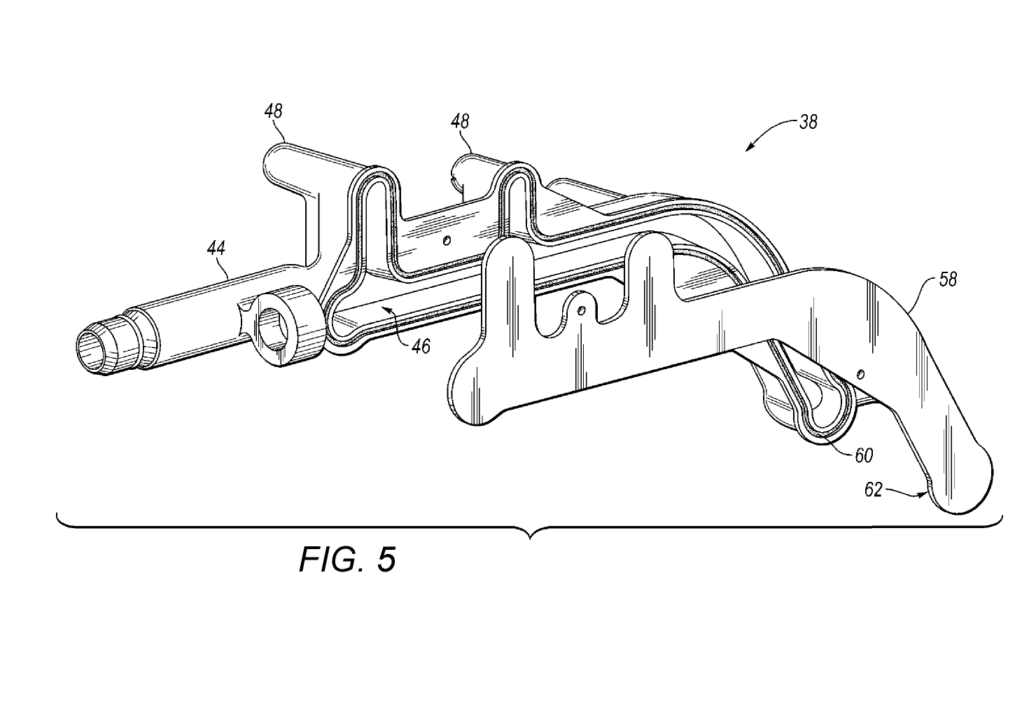

Referring to FIGS. 4 and 5, a substantially flat cover 58 is provided that cooperates with the main body 44 to enclose the internal channel 46 and create a fluid seal. The simple shape of cover 58 is conducive to injection molding and reduces tooling costs. Both of the main body 44 and the cover 58 may be formed in a single injection molding tool having multiple mold cavities.

The main body 44 also defines a groove 60 along each of an opposing pair of edges on either side of the internal channel 46. The groove 60 defines a continuous path around the perimeter of the open side of the internal channel 46. The groove 60 receives a corresponding rib 62 disposed on the cover 58. The rib 62 nests in the corresponding shape of groove 60 to provide contact with multiple surfaces along a continuous path around the perimeter of the internal channel 46. The rib 62 creates a fluid seal when inserted into the groove 60. The cover 58 may be affixed to the main body 44 by adhesion, laser welding, or vibration friction welding to create a sealed seam joint between the cover 58 and the main body 44. In a preferred example, the cover 58 is joined by vibration friction welding. In alternative configurations, a recessed shoulder may be provided on each opposing side of the internal channel for receiving the cover. Mounting features 64 may be integrally molded into at least one of the main body 44 or the cover 58. The manifold 38 may be attached to corresponding features on an inner portion of the case 12 of the transmission.

Under extreme conditions, operating temperatures of the lubricant within the transmission may exceed 100 degrees Celsius. The manifold must be configured to maintain stiffness and dimensional stability at high operating temperatures. The manifold may injection molded from a resilient elastomer such as Polyamide 46. The elastomer preferably includes a predetermined volume of embedded glass fibers. In one example, the manifold 38 may have a wall thickness of about 2.5 mm.

Referring back to FIG. 1, the first section 20 and the second section 22 of the internal cavity 14 of the transmission are substantially separated by the mid-wall 24. The first section 20 includes the sump 26 that collects lubricant that drains to the bottom of the internal cavity 14. It may be desirable to limit the size of the sump and keep the second section 22 dryer than the first section 20 by retaining little or no fluid at the bottom of the second section 22. In this way, fluid sloshing due to vehicle and traction component movement may be reduced.

A second manifold 66 may be used in conjunction with the first manifold 38 to provide a comprehensive transmission lubrication system. In at least one example, a first manifold and a second manifold are in series fluid flow communication to separately lubricate traction components within the first section 20 and the second section 22, respectively. The first and second manifolds 38, 66 may be fluidly connected to each other at the mid-wall 24 to distribute lubricant from one to the other. It may be desirable to arrange the first manifold 38 and the second manifold 66 in different orientations depending on the layout of the internal components within the transmission 10. The first manifold 38 may be elongate and oriented in a generally horizontal direction. The second manifold 66 may be elongate and oriented in a generally vertical direction.

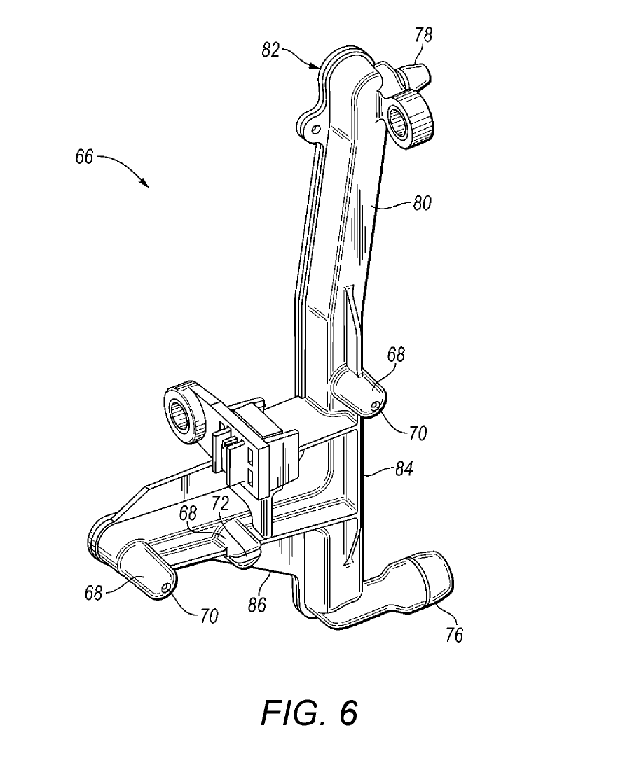

Referring to FIG. 6, the second manifold 66 includes a plurality of ports 68 that are arranged to distribute lubricant to respective transmission components. The second manifold 66 is also provided with multiple orifice types to disperse lubricant in different patterns as best suited to particular traction components of the transmission 10. The ports 68 may define a combination of simple orifices 70 to divert the lubricant from the manifold 66 in a solid stream spray pattern 52. An elongate orifice 72 may be used to divert the lubricant from it the manifold 66 in a fan spray pattern 56 to provide a wider lubricant coverage area.

The second manifold 66 may also be constructed as a main body 80 joined to a cover 82. Similar to the first manifold discussed above, the cover 82 provides a fluid seal and encloses an internal channel to contain lubricant as it flows through the second manifold 66. The main body 80 is formed by injection molding to facilitate including various stiffening ribs 82 and gussets 84 that enhance the overall rigidity of the manifold.

The two manifolds cooperate to provide lubricant recirculation through the transmission. The exhaust nozzle 74 of the first manifold expels lubricant cycled through the manifold that is not dispersed from one of the outlet ports 48. The exhaust nozzle 74 is in fluid flow communication with a supply nozzle 76 of the second manifold 66 at a pass-through portion of the mid-wall 24. The second manifold 66 also includes a corresponding exhaust nozzle 78 that expels lubricant not dispersed by the ports 68. However, in the case of the second manifold 66, the lubricant is expelled to return back to the sump 26 for circulation. The exhaust nozzle 78 is directs lubricant through a pass-through portion of the mid-wall 24 to the first section 20 to drain back to the sump 26. In alternative configurations, the second manifold 66 may exhaust to a lubricant cooling system external to the transmission 10 prior to being directed back to the sump 26. Lubricant may be directed through the cooling system before dispersion across the traction components of the transmission 10 to aid in preventing excessive heat build-up.

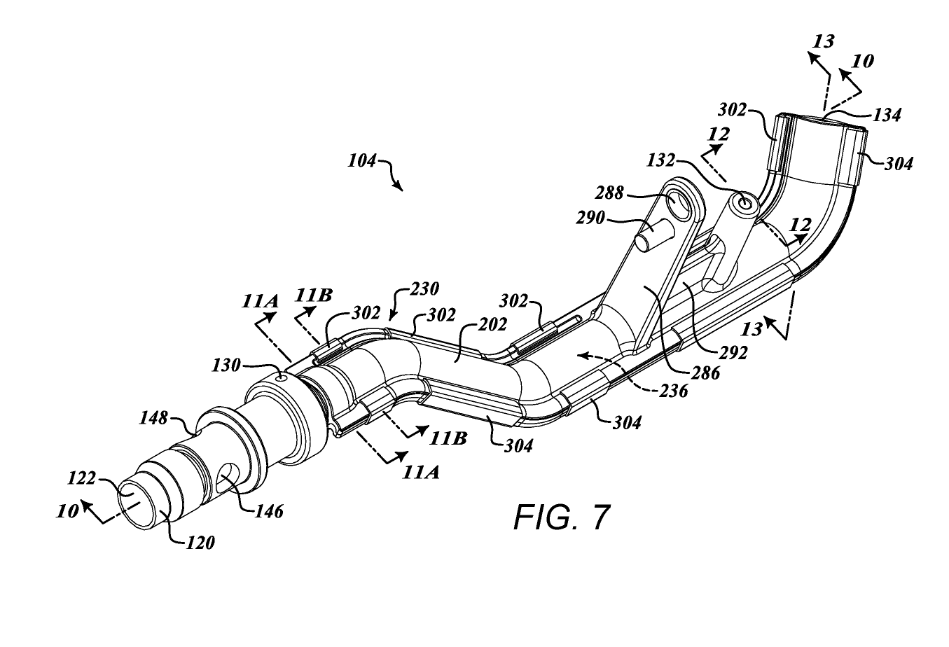

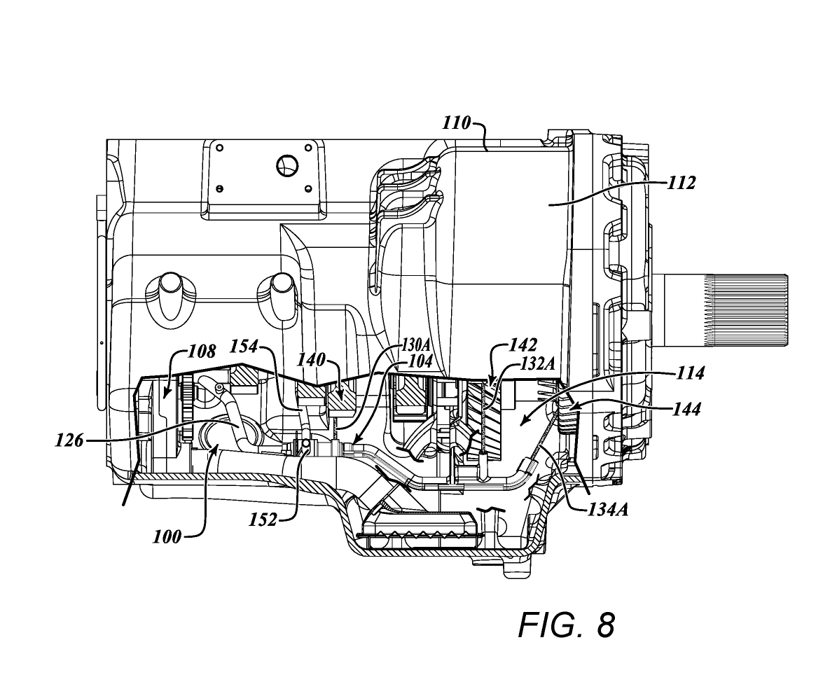

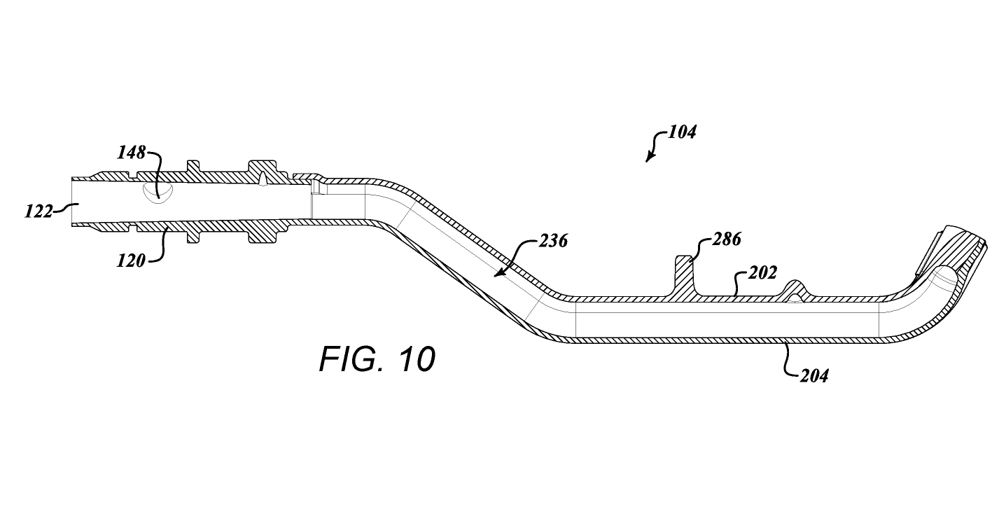

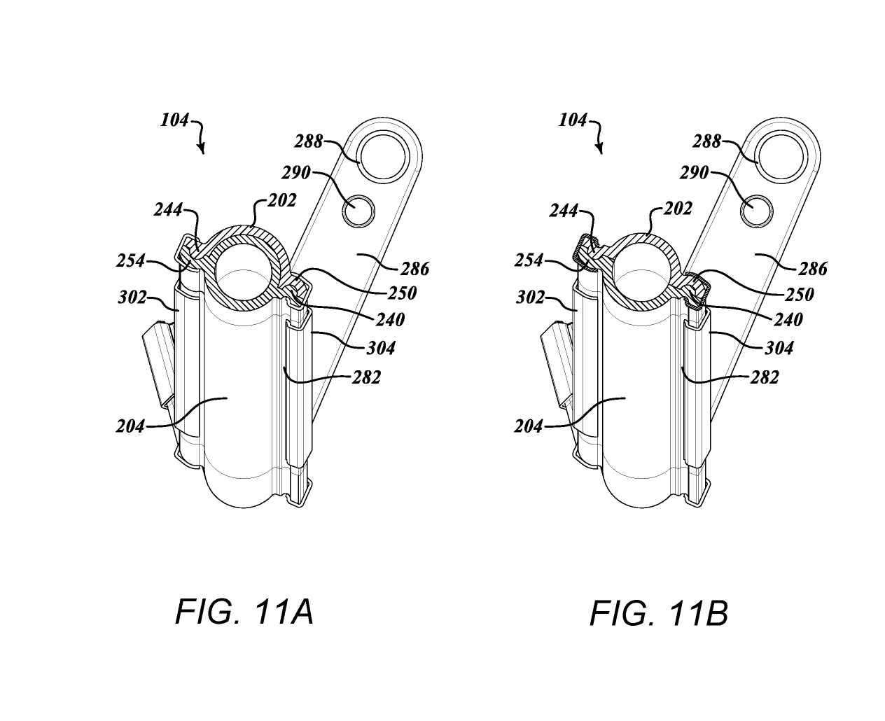

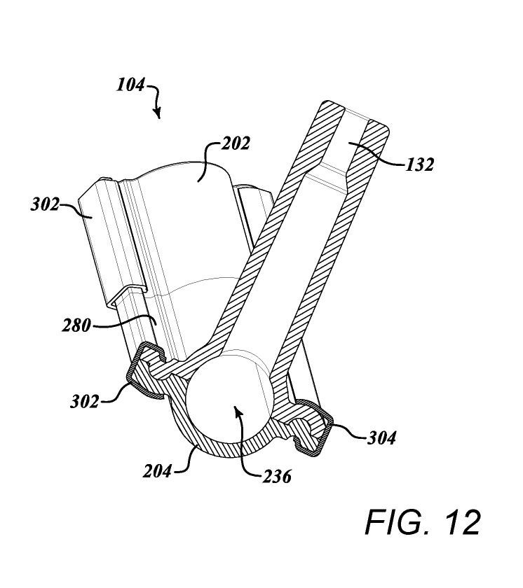

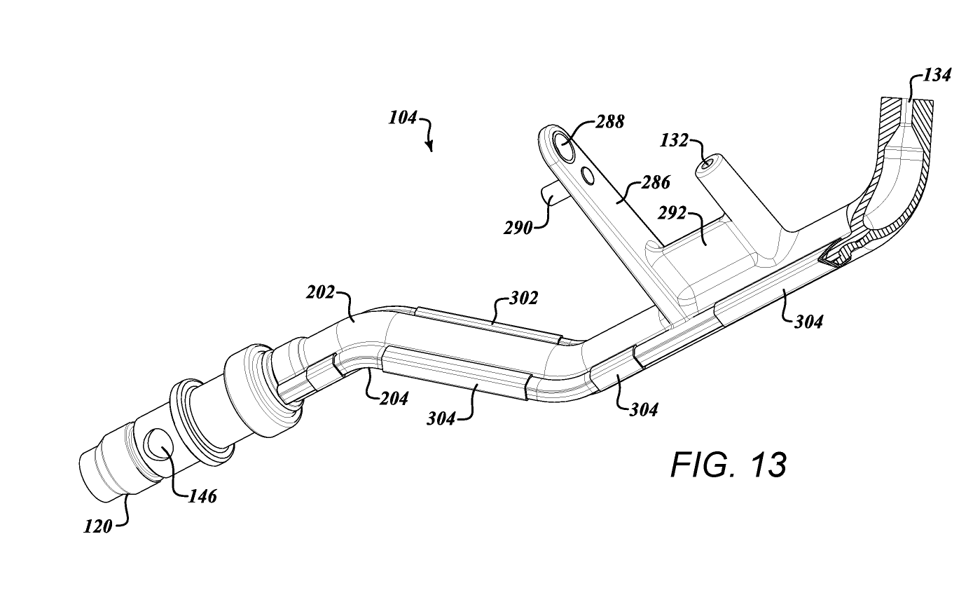

With reference now to FIGS. 7-13, a lubrication system constructed in accordance to additional features of the present disclosure is shown and generally identified at reference numeral 100 (FIG. 8). As will become appreciated from the following discussion, the lubrication system 100 includes a manifold 104 that receives lubricant from a pump 108 and distributes the lubricant to various areas of the transmission 110. The transmission 110 includes an outer housing or case 112 defining an internal cavity 114 that contains components of the transmission 110. The case 112 may be made from one or more castings, forgings or other parts. The transmission 110 receives input torque from an engine connection and delivers output torque at a driveline connection. The case 112 encloses a gear train that has a plurality of traction components that are adjustable to vary the ratios of both the speed and torque of the output relative to the input. The exemplary transmission 110 includes meshed gears that require sufficient lubrication to maintain efficient operation, reduce drag and prevent excessive heat build-up.

As will be described in greater detail herein, the manifold 104 receives and distributes lubricant in addition to having outlet ports configured as spray orifices on it. Specifically, the manifold 104 has an inlet supply nozzle 120 that defines an opening 122 that receives lubricant from the pump 108 by way of a connecting tube 126. The manifold 104 has a plurality of outlet ports comprising a first outlet port 130, a second outlet port 132 and a third outlet port 134. Lubricant is sprayed out of the manifold 104 through each of the first, second and third outlet ports 130, 132 and 134.

With specific reference to FIG. 8, lubricant, identified as stream 130A, exits the first outlet port 130 and is directed onto a first gear mesh 140. Lubricant, identified as stream 132A, exits the second outlet port 132 and is directed onto an auxiliary drive mesh 142. Lubricant, identified as stream 134A, exits the third outlet port 134 and is directed onto an auxiliary reduction gear mesh 144. Lubricant is further directed out of the manifold 104 through a fourth outlet port 146 and a fifth outlet port 148 (FIG. 7). The fourth outlet port 146 is fluidly connected to an upper reverse idler tube 152. The fifth outlet port 148 is fluidly connected to a lower reverse idler tube 154. It will be appreciated that the manifold 104 may have additional or fewer outlet ports for distributing and communicating lubricant through tubes and/or as spray to other components of the transmission 110.

Additional features of the manifold 104 will now be described. The manifold 104 includes the inlet supply nozzle 120, a first body portion 202 and a second body portion 204. The inlet supply nozzle 120, first body portion 202 and second body portion 204 can be formed of injection molded plastic. As will be described, the manifold 104 comprises two distinct portions, the first body portion 202 and the second body portion 204 that are coupled together.

The first and second body portions 202 and 204 are in fluid communication with the inlet supply nozzle 120. In the particular example, the inlet supply nozzle 120 is integrally formed with the second body portion 204. The inlet supply nozzle 120 comprises a completely formed annular end of the second body portion 204. The first body portion 202 defines a first channel 212 having a first open side 216 along the first channel 212. The second body portion 204 defines a second channel 222 having a second open side 226 along the second channel 222. The first and second body portions 202 and 204 connect to form an assembled body 230 (FIG. 7) in an assembled position such that the first and second channels 212 and 222 collectively define a main tubular passage 236. The main tubular passage 236 communicates lubricant through the manifold 104.

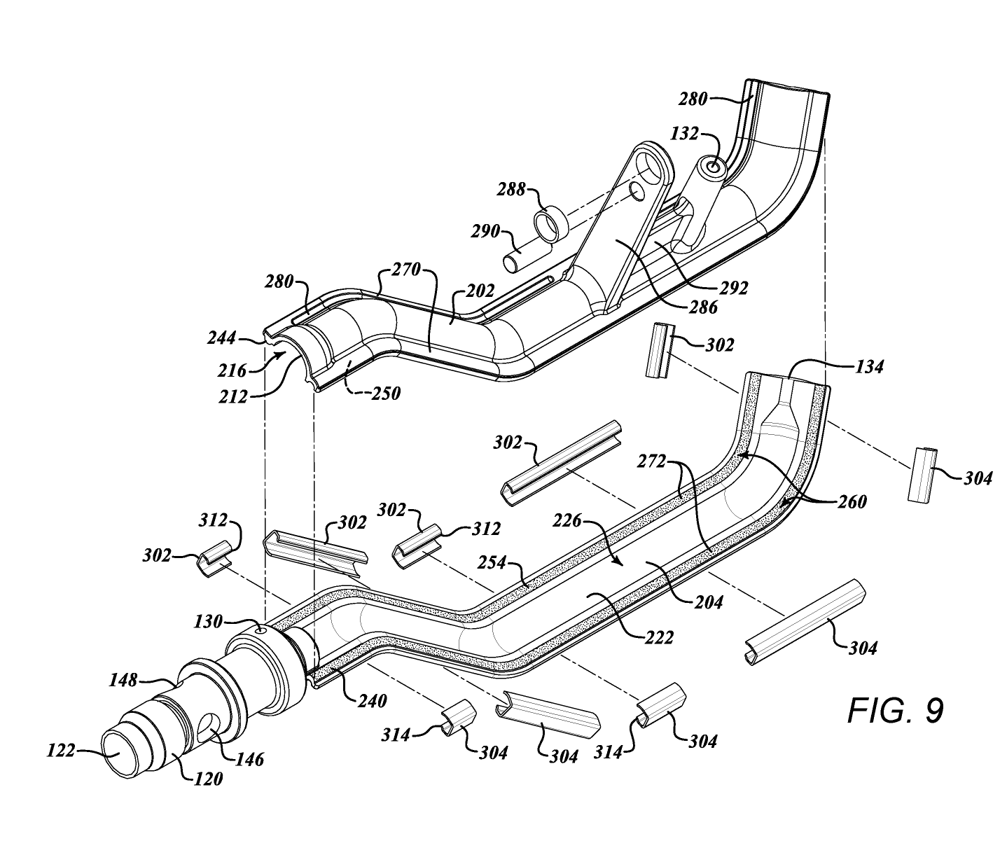

With particular reference now to FIG. 9, additional features of the manifold 104 will be described. A first male extension portion 240 can be formed on the second body portion 204. A second male extension portion 244 can be formed on the first body portion 202. A first female receiving portion 250 can be formed on the first body portion 202. A second female receiving portion 254 can be formed on the second body portion 204. When assembled, the first male extension portion 240 can be nestingly received by the first female receiving portion 250. Similarly, the second male extension portion 244 can be nestingly received by the second female receiving portion 254. Adhesive and/or sealant 260 can be further applied between the complementary male and female receiving portions 240, 250 and 244, 254. The sealant 260 forms a seal between the first and second body portions 202 and 204 and couples the first and second body portions 202 and 204 together.

The first body portion 202 includes a first pair of outwardly extending flanges 270. The second body portion 204 includes a second pair of outwardly extending flanges 272 that oppose the first pair of flanges 270. In the example shown, the second male extension portion 244 and the first female receiving portion 250 are formed on the first pair of flanges 270. The first male extension portion 240 and the second female receiving portion 254 are formed on the second pair of flanges 272. The first body portion 202 can further include first grooves 280 formed on a flange of the first pair of flanges 270. The second body portion 204 can further include second grooves 282 formed on a flange of the pair of second flanges 272.

The first body portion 202 can further include an upwardly extending support bracket 286 having an insert-molded torque limiter 288 and pin 290 thereon. A support flange 292 can connect between the support bracket 286 and the second outlet port 132. The torque limiter 288 and pin 290 can be used to mount the manifold 104 to the case 112. In one configuration the torque limiter 288 is engaged with an intermediate wall of the case 112. The pin 290 is used to limit rotational movement of the manifold 104 while tightening an associated fastener (not specifically shown) extending through the insert-molded torque limiter 288 thus maintaining desired oil stream targeting.

A series of clips 302 and 304 can be located around opposing flanges of the first and second pairs of flanges 270, 272. The clips 302 and 304 can further couple the first and second body portions 202 and 204 together. The clips 302 and 304 can be formed of sheet steel and be crimped around the flanges 270, 272. The clips 302 can have fingers 312 that locate into the grooves 280 of the first body portion 202. The clips 304 can have fingers 314 that locate into the grooves 282 of the second body portion 204. In some examples, the crimping will deform the clips 302, 304 around the flanges. In one configuration, the adhesive and/or sealant 260 sufficiently couples the first and second body portions 202, 204 such that the clips 302 and 304 are optional.

The examples described above are specific examples that do not describe all possible forms of the disclosure. The features of the illustrated examples may be combined to form further examples of the disclosed concepts. The words used in the specification are words of description rather than limitation. The scope of the following claims is broader than the specifically disclosed examples and also includes modifications of the illustrated examples.

1. A manifold for distributing lubricant in a transmission comprising:
an inlet supply nozzle for receiving transmission lubricant;
a first body portion in fluid communication with the supply nozzle and defining a first channel having a first open side along the first channel;
a second body portion in fluid communication with the supply nozzle and defining a second channel having a second open side along the second channel, wherein the first and second body portions connect to form an assembled body in an assembled position such that the first and second channels collectively define a main tubular passage;
a male extension portion formed on one of the first and second body portions;
a female receiving portion formed on the other of the first and second body portions, wherein the male extension portion is received by the female receiving portion in the assembled position; and
a plurality of outlet ports extending from the assembled body for dispersing lubricant from the main tubular passage across traction components of the transmission.

2. The manifold of claim 1 wherein the inlet supply nozzle comprises a completely formed annular end of one of the first and second body portions.

3. The manifold of claim 2 wherein the outlet ports comprise:
a first outlet port arranged to direct lubricant onto a first gear mesh of the transmission;
a second outlet port arranged to direct lubricant onto an auxiliary drive of the transmission; and
a third outlet port arranged at a terminal end of the manifold and arranged to direct lubricant onto an auxiliary reduction gear mesh of the transmission.

4. The manifold of claim 3 wherein the outlet ports further comprise:
a fourth outlet port configured to be fluidly connected to an upper reverse idler tube; and
a fifth outlet port configured to be fluidly connected to the lower reverse idler tube;
wherein the fourth and fifth outlet ports are defined in the inlet supply nozzle.

5. The manifold of claim 2 wherein the first body portion includes a first pair of outwardly extending flanges.

6. The manifold of claim 5 wherein the second body portion includes a second pair of outwardly extending flanges that oppose and engage the first pair of outwardly extending flanges in the assembled position.

7. The manifold of claim 6 wherein the male extension portion is formed on a flange of the first pair of outwardly extending flanges and the female receiving portion is formed on an opposing flange of the second pair of outwardly extending flanges.

8. The manifold of claim 6 wherein the male extension portion comprises at least two distinct male extension portions, a first male extension portion extending from a flange of the first pair of outwardly extending flanges and a second male extension portion extending from a flange of the second pair of outwardly extending flanges.

9. The manifold of claim 8 wherein the female receiving portion comprises at least two distinct female receiving portions, a first female receiving portion formed on a flange of the first pair of outwardly extending flanges and a second female extension portion extending from a flange of the second pair of outwardly extending flanges.

10. The manifold of claim 9, further comprising one of adhesive and sealant disposed between opposing flanges of the first and second pairs of outwardly extending flanges.

11. The manifold of claim 9, further comprising at least one clip disposed around opposing flanges of the first and second pairs of outwardly extending flanges.

12. The manifold of claim 11 wherein the clips have opposite distal ends that are nestingly received into complementary grooves formed in the opposing flanges of the first and second pairs of outwardly extending flanges.

13. The manifold of claim 2 wherein the inlet supply nozzle is formed on the second body portion and wherein the first body portion comprises an upwardly extending support bracket having an insert-molded torque limiter and pin thereon, the insert-molded torque limiter and pin facilitating mounting of the upwardly extending support bracket to internal structure of the transmission.

14. A manifold for distributing lubricant in a transmission comprising:
an inlet supply nozzle for receiving transmission lubricant;
a first body portion in fluid communication with the supply nozzle and defining a first channel having a first open side along the first channel;
a second body portion in fluid communication with the supply nozzle and defining a second channel having a second open side along the second channel, wherein the first and second body portions connect to form an assembled body in an assembled position such that the first and second channels collectively define a main tubular passage;
a plurality of outlet ports extending from the assembled body for dispersing lubricant from the main tubular passage across traction components of the transmission; and
wherein the inlet supply nozzle comprises a completely formed annular end of one of the first and second body portions.

15. The manifold of claim 14, further comprising:
a male extension portion formed on one of the first and second body portions; and
a female receiving portion formed on the other of the first and second body portions, wherein the male extension portion is received by the female receiving portion in the assembled position.

16. The manifold of claim 14 wherein the outlet ports comprise:
a first outlet port arranged to direct lubricant onto a first gear mesh of the transmission;
a second outlet port arranged to direct lubricant onto an auxiliary drive of the transmission; and
a third outlet port arranged at a terminal end of the manifold and arranged to direct lubricant onto an auxiliary reduction gear mesh of the transmission.

17. The manifold of claim 16 wherein the outlet ports further comprise:
a fourth outlet port configured to be fluidly connected to an upper reverse idler tube; and
a fifth outlet port configured to be fluidly connected to the lower reverse idler tube;
wherein the fourth and fifth outlet ports are defined in the inlet supply nozzle.

18. The manifold of claim 15 wherein the first body portion includes a first pair of outwardly extending flanges.

19. The manifold of claim 16 wherein the second body portion includes a second pair of outwardly extending flanges that oppose and engage the first pair of outwardly extending flanges in the assembled position.

20. The manifold of claim 14 wherein the inlet supply nozzle is formed on the second body portion and wherein the first body portion comprises an upwardly extending support bracket having an insert-molded torque limiter and pin thereon, the insert-molded torque limiter and pin facilitating mounting of the upwardly extending support bracket to internal structure of the transmission.
